(19) United States
(12) Patent Application Publication
(10) Pub. No.: US 2024/0420016 A1
(43) Pub. Date: Dec. 19, 2024

(54) METHOD AND SYSTEM FOR GENERATING SYNTHETIC TRAINING DATA FOR TRAINING AN ARTIFICIAL INTELLIGENCE (AI) MODEL USABLE TO OPERATE A TRAIN

(71) Applicant: Progress Rail Locomotive Inc., LaGrange, IL (US)

(72) Inventors: Marcos Blanco FERNANDES, Irving, TX (US); Sammy AKIF, Northlake, TX (US); Alex Karyagdy WILLIAMS, Houston, TX (US); Michel Edward LACLE, Florida City, FL (US); Frederick Gary SILCOX, Melrose, FL (US)

(73) Assignee: Progress Rail Locomotive Inc., LaGrange, IL (US)

(21) Appl. No.: 18/335,465

(22) Filed: Jun. 15, 2023

(51) Int. Cl. G06N 20/00

(52) U.S. Cl. CPC G06N 20/00

(57) ABSTRACT

Systems and methods of generating synthetic training data for training an AI model usable to operate a train are disclosed. A method of generating the synthetic training data includes obtaining run data corresponding to a real-world run of the train. The method includes generating a physics-based simulation of the real-world run of the train. The method includes receiving a user input modifying at least one operation command of the train in the physics-based simulation. The method includes updating the physics-based simulation based on the received user input. The method includes generating the synthetic training data for training the AI model, based on the updated physics-based simulation.

### TECHNICAL FIELD

The present disclosure relates generally to methods and systems for generating synthetic training data for training an AI model usable to operate a train, and more particularly, to methods and systems for generating synthetic training data based on user inputs modifying operation commands in a physics-based simulation of a train.

### BACKGROUND

An AI model may be used to operate a train. For example, the AI model may control a throttle of the train, an air brake of the train, etc. There may be advantages to training an AI model using training data that reflects proper driving behavior and strategy, and or that corresponds to characteristics of the train to be controlled or the environment to be navigated. In many instances, however, the quality and/or availability of the training data used to train the AI model may be a significant determinant of the success of the AI model at predicting and learning appropriate driving behavior. That is, the quality and quantity of the training data may affect how the AI model controls the train on a run along a route, and thereby affects various characteristics of the run (e.g., fuel efficiency, ride quality, total run time, etc.).

In some cases, run data from real-world runs may be used as training data. The run data may reflect driving behavior that provides insights and tribal knowledge about how to control a train on a particular track along a particular route. However, the run data might also reflect improper driving behavior and/or driving behavior associated with human error at particular locations along the route. In some cases, the run data might be corrected to remove the portions of the data that reflect the improper driving behavior and/or driving behavior associated with human error. However, this approach generally requires a significant quantity of training data set with high variability (as much of the data may be pruned when accounting for human error or bad behavior, etc.), which is often not the case with railroad operations. For example, after segmenting the training data by train type, consist information, train performance, track geography, speed restrictions, and weather information, the amount of the usable data for the training data set might be insufficient for training purposes.

In some cases, simulation data may be used as training data. This approach may rely on optimization tools that establish appropriate success criteria to balance mathematical optimums with practicality. However, this is very difficult to achieve in relation to complex problems such as driving a train.

A method of training a control device of a rail vehicle is disclosed in Chinese Patent Number 114802370A. The method includes providing training data based on sensor data of the rail vehicle, training a proxy model of the rail vehicle in terms of a relation between the control of the drive of the rail vehicle and the generated speed of the rail vehicle based on the training data, and training an action selection rule with machine learning and taking into account at least one objective control objective based on the training data and the proxy model. However, Chinese Patent Number 114802370A is silent regarding training an AI model for operating a train based on synthetic data that is generated based on user inputs modifying operation commands in a physics-based simulation.

The disclosed method and system may solve one or more of the problems set forth above and/or other problems in the art. The scope of the current disclosure, however, is defined by the attached claims, and not by the ability to solve any specific problem.

### SUMMARY

In one aspect, an exemplary embodiment of generating synthetic training data for training an AI model usable to operate a train includes a method including obtaining run data corresponding to a real-world run of the train, the run data including control parameter information indicative of operation commands issued to the train during the run; generating a physics-based simulation of the real-world run of the train, based on the run data; receiving a user input modifying at least one operation command of the train in the physics-based simulation; updating the physics-based simulation based on the received user input; and generating the synthetic training data for training the AI model, based on the updated physics-based simulation.

In another aspect, an exemplary embodiment of generating synthetic training data for training an AI model usable to operate a train includes a device including a memory configured to store instructions, and a processor configured to execute the instructions to perform operations comprising: obtaining run data corresponding to a real-world run of the train, the run data including control parameter information indicative of operation commands issued to the train during the run; generating a physics-based simulation of the real-world run of the train, based on the run data; receiving a user input modifying at least one operation command of the train in the physics-based simulation; updating the physics-based simulation based on the received user input; and generating the synthetic training data for training the AI model, based on the updated physics-based simulation.

In a further aspect, an exemplary embodiment of generating synthetic training data for training an AI model usable to operate a train includes a non-transitory computer-readable medium configured to store instructions that, when executed by a processor configured to generate synthetic training data for training an artificial intelligence (AI) model usable to operate a train, cause the processor to perform operations comprising: obtaining run data corresponding to a real-world run of the train, the run data including control parameter information indicative of operation commands issued to the train during the run; generating a physics-based simulation of the real-world run of the train, based on the run data; receiving a user input modifying at least one operation command of the train in the physics-based simulation; updating the physics-based simulation based on the received user input; and generating the synthetic training data for training the AI model, based on the updated physics-based simulation.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of an exemplary system for generating synthetic training data for training an AI model usable to operate a train, according to aspects of the present disclosure.

FIG. 2 is a diagram of exemplary components of one or more devices of FIG. 1, according to aspects of the present disclosure.

FIG. 3 is a flowchart of a method of generating synthetic training data for training an AI model usable to operate a train, according to aspects of the present disclosure.

FIGS. 4A-4E is an exemplary user interface for generating synthetic training data for training an AI model usable to operate a train, according to aspects of the present disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. The term “or” is used disjunctively, such that “at least one of A or B” includes, A, B. A and A, A and B, etc. Moreover, in this disclosure, relative terms, such as, for example, “about,” “substantially,” “generally,” and “approximately” are used to indicate a possible variation of ±10% in the stated value.

As addressed above, the quality of training data affects how the trained AI model controls the train. Moreover, as addressed above, the utilization of run data or simulation data for training an AI model might be inadequate. Further still, related techniques for training an AI model might not account for bad behavior or human error during a real-world train run and/or changes in characteristics of the train or environment between run data and a scenario being trained for. Accordingly, a need exists for improvements to technique for generating training data for AI models usable to operate a train.

In light of the foregoing, the present disclosure provides systems and methods for generating synthetic training data for training an AI model usable to operation a train. The systems and methods may obtain run data corresponding to a real-world run of the train, and generate a physics-based simulation of the real-world run of the train. A user, using a user device, may provide user inputs modifying operation commands of the train in the physics-based simulation. The systems and methods may update the physics-based simulation based on the user inputs, and generate the synthetic training data based on the updated physics-based simulation. In this way, a user may provide user inputs that modify operation commands in a physics-based simulation to generate synthetic training data for training an AI model. Accordingly, the synthetic training data may be used to train AI models that more accurately operate a train, that more safely operate a train, that more efficiently operate a train, etc. As such, the present disclosure provides a technical improvement related to generating synthetic training data for training AI models, and provides a technical improvement in the operation of trains that utilize such trained AI models.

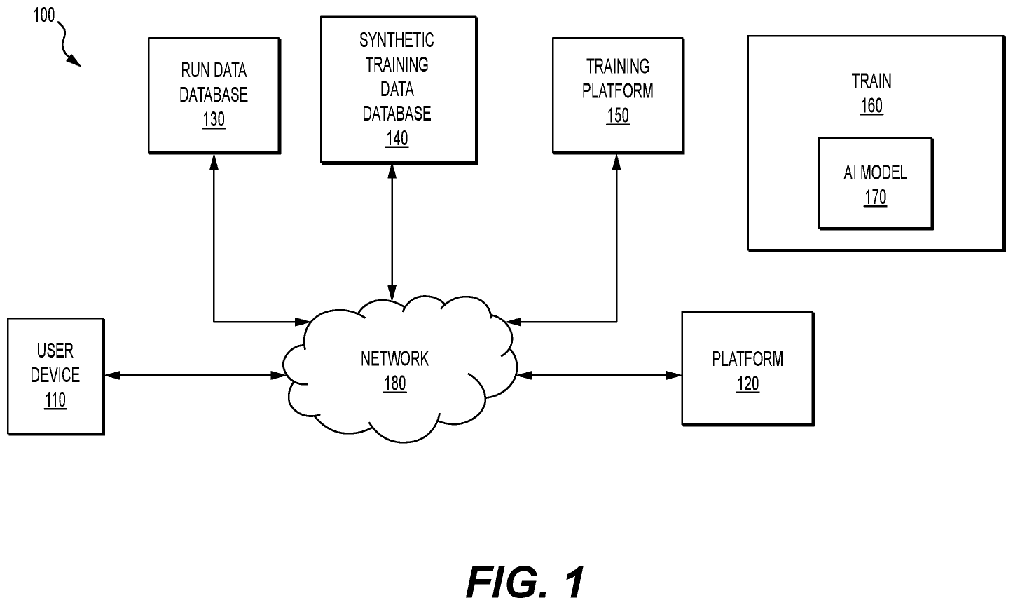

FIG. 1 illustrates an exemplary system 100 including a user device 110, a platform 120, a run data database 130, a synthetic training data database 140, a training platform 150, a train 160, an AI model 170, and a network 180.

The user device 110 may be a device configured to display a user interface for generating synthetic training data. For example, the user device 110 may be a desktop computer, a laptop computer, a smartphone, a wearable device, a server, or the like. The user interface may enable a user of the user device 110 to access and/or interact with other components of the system 100.

The platform 120 may be a device configured to obtain run data corresponding to a real-world run of the train 160, generate a physics-based simulation of the real-world run of the train 160, receive a user input modifying at least one operation command of the train 160 in the physics-based simulation, update the physics-based simulation based on the received user input, and generate synthetic training data for training the AI model 170. For example, the platform 120 may be a server, a cloud server, a virtual machine, or the like.

The run data database 130 may be a device configured to store run data corresponding to a real-world run of the train 160. For example, the run data database 130 may be a centralized database, a distributed database, a cloud database, a network database, a hierarchical database, or the like.

A real-world run of a train 160 may refer to an actual real-world run of a train 160 on a track along a route from an initial location to a destination. The run data may correspond to the real-world run of the train 160. The train 160 may collect the run data based on the train 160 travelling on the route. For example, components, sensors, etc., of the train 160 may generate or collect the run data as the train 160 travels along the route. Moreover, external data sources may provide, or generate, a portion of the run data. For example, as described below in more detail, the run data may include weather information. In this case, the weather information might be received from an external data source, such as a database that stores weather information pertaining to the route.

The run data may include control parameter information. The control parameter information may be indicative of operation commands issued to the train 160 during the run. For example, the control parameter information may correspond to any component of the train of the train 160, and may be indicative of operation commands issued to the components of the train 160 during the run. As an example, the control parameter information may be indicative of a throttle command issued to a throttle of the train 160 (e.g., a throttle of a lead locomotive of the train 160, a throttle of a remote unit of the train 160, etc.), a dynamic brake command issued to a dynamic brake of the train 160, an air brake command issued to an air brake of the train 160, or the like. The control parameter information may be correlated with location information of the run. The location information may identify a particular location of the run to which the control parameter information pertains. For example, the location information may be a milepost, a geographic coordinate, a location identifier, or the like.

The run data may include track information of the route. The track information may identify a curvature of the track, may identify an elevation of the track, a type of the track, or the like. The run data may include signaling information of the route. For example, the signaling information may identify signals of the route, speed restrictions of the route, track speeds of the route, work zones along the route, or the like. The run data may include train consist information of the train 160. The train consist information may include a train identifier of the train 160, a model identifier of the train 160, a number of locomotives of the train 160, a number of remote units of the train 160, a number of cars of the train 160, a weight distribution of the train 160, a cargo of the train, or the like. The run data may include environment information of the run. For example, the environment information may include weather information of the run, a date of the run, a time of the run, visibility during the run, or the like.

The synthetic training data database 140 may be a device configured to store synthetic training data for training the AI model 170. For example, the synthetic training data database 140 may be a centralized database, a distributed database, a cloud database, a network database, a hierarchical database, or the like.

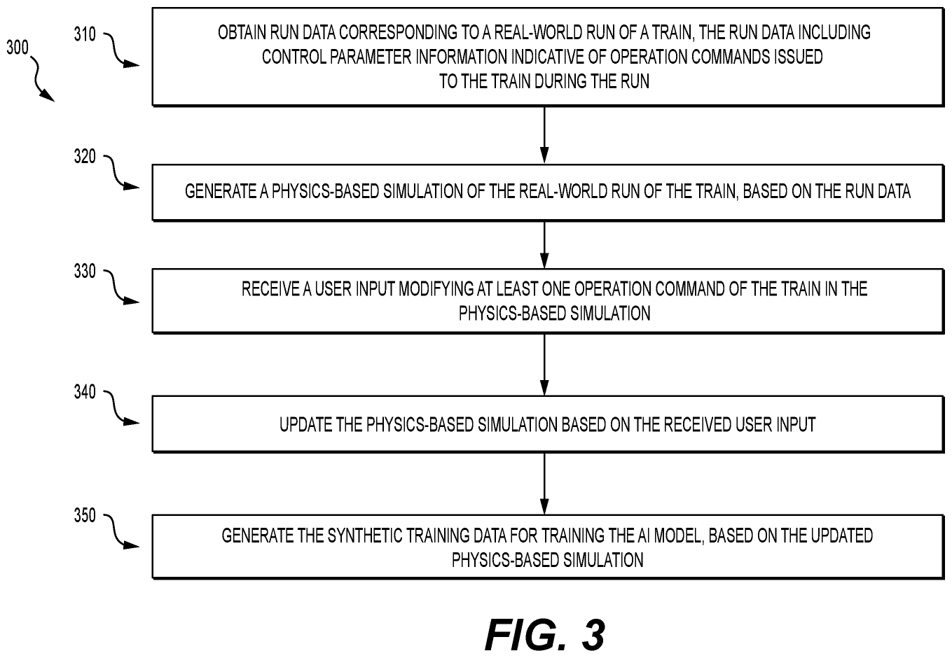

The synthetic training data may include control parameter information, track information of the route, signaling information of the route, train consist information, environment information of the run, or the like. In this way, the synthetic training data may include a data structure that is similar to the run data. Moreover, the synthetic training data may be based on the run data. Accordingly, the synthetic training data and the run data may include some of the same values for the control parameter information, track information of the route, signaling information of the route, train consist information, environment information of the run, or the like. However, the synthetic training data may include control parameter information including modified operation commands. The modified operation commands may be generated based on user inputs provided in the physics-based simulation. For instance, and as described in more detail in connection with FIG. 3, a user may provide user inputs modifying one or more operation commands of the train 160 in the physics-based simulation. The synthetic training data may include control parameter information that reflects the modified operation commands. Moreover, the synthetic training data may include information that identifies the extent to which the run data was modified to produce the modified operation commands. In this way, the synthetic training data may include some values that are different than the values of the run data based on the modified operation commands, and may include information identifying the extent of the change of the values.

The training platform 150 may be a device configured to train the AI model 170 using synthetic training data. For example, the training platform 150 may be a server, a cloud server, a virtual machine, or the like.

The train 160 may be a series of connected vehicles that runs along a track. For example, the train 160 may be a passenger train, a freight train, a mixed train, a heavy rail train, a light rail train, or the like. According to some embodiments of the disclosure, the run data may correspond to a first train 160 (or a first set of trains 160), and the AI model 170 may be usable to operate a second, different, train 160. Alternatively, according to some embodiments of the disclosure, the run data may correspond to a train 160, and the AI model 170 may be usable to operate the same train 160. The train 160 may include sensors that generate sensor data. For example, the sensors may include a throttle sensor, a speed sensor, a vibration sensor, a pressure sensor, a humidity sensor, a temperature sensor, a level sensor, etc. The run data may be generated based on the sensor data. That is, the sensor data may be used to generate the control parameter information, track information of the route, signaling information of the route, train consist information, environment information of the run, or the like. In some instances, sensor data may be obtained from sensors not included on a train. For example, one or more sensors on or near a track, a station, a switch, or other location, etc., may be configured to take measurements, e.g., a speed, weight, timing, or the like of a passing train, weather conditions, etc.

The AI model 170 may be a model usable to operate the train 160. For example, the AI model 170 may be a neural network, a linear regression model, a logistic regression model, a decision tree, a support vector machine, or the like.

The network 180 may be a network that permits communication between the devices of FIG. 1. For example, the network 180 may be a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of the devices of the system 100 shown in FIG. 1 are provided as an example. In practice, the system 100 may include additional devices, fewer devices, different devices, or differently arranged devices than those shown in FIG. 1. Additionally, or alternatively, a set of devices (e.g., one or more devices) of the system 100 may perform one or more functions described as being performed by another set of devices of the system 100.

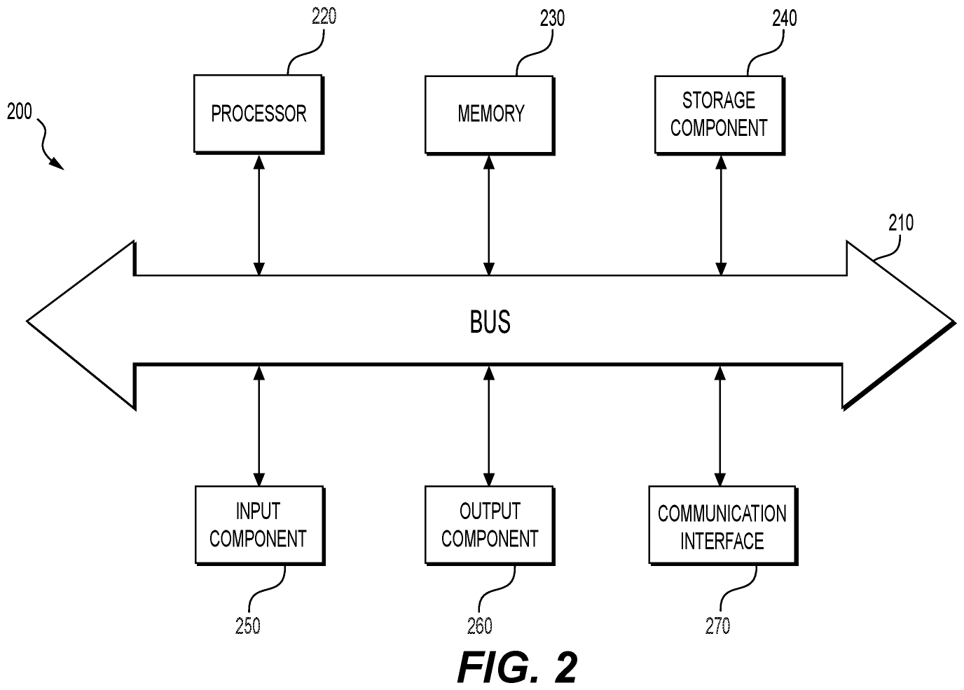

FIG. 2 illustrates example components of a device 200. The device 200 may correspond to the user device 110, the platform 120, the run data database 130, the synthetic training data database 140, the training platform 150, the train 160, and/or the AI model 170. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 may be implemented in hardware, firmware, or a combination of hardware and software. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component.

The processor 220 may include one or more processors capable of being programmed to perform a function. The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone for receiving the reference sound input). Additionally, or alternatively, the input component 250 may include a sensor for sensing information (e.g., a global positioning system (GPS) component, an accelerometer, a gyroscope, and/or an actuator). The output component 260 may include a component that provides output information from the device 200 (e.g., a display, a speaker for outputting sound at the output sound level, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes based on the processor 220 executing software instructions stored by a non-transitory computer-readable medium, such as the memory 230 and/or the storage component 240. A computer-readable medium may be defined herein as a non-transitory memory device. A memory device may include memory space within a single physical storage device or memory space spread across multiple physical storage devices.

The software instructions may be read into the memory 230 and/or the storage component 240 from another computer-readable medium or from another device via the communication interface 270. When executed, the software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of the components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

### INDUSTRIAL APPLICABILITY

As addressed above, the present disclosure provides systems and methods that generate, based on user inputs, synthetic training data that may be used to train AI models that more accurately operate a train, that more safely operate a train, that more efficiently operate a train, etc. As such, the present disclosure provides a technical improvement related to generating synthetic training data for training AI models, and provides a technical improvement in the operation of trains that utilize such trained AI models.

The embodiments herein may be applicable to any type of train, such as grain transport trains, express trains, rapid transit trains, high-speed rail trains, monorail trains, passenger trains, freight trains, commuter rail trains, or the like.

The embodiments herein may be applicable to any type of AI model, such as a neural network (e.g., a deep neural network, an artificial neural network, etc.), a logistic regression model, a random forest model, a support vector machine, a reinforcement learning model, a transformer, or the like.

Moreover, although the embodiments herein are described in connection with runs of trains, it should be understood that the embodiments herein are applicable to other types of movement patterns of vehicles with constrained or on-rail motion, such as construction or mining equipment, robots in a factory, or the like.

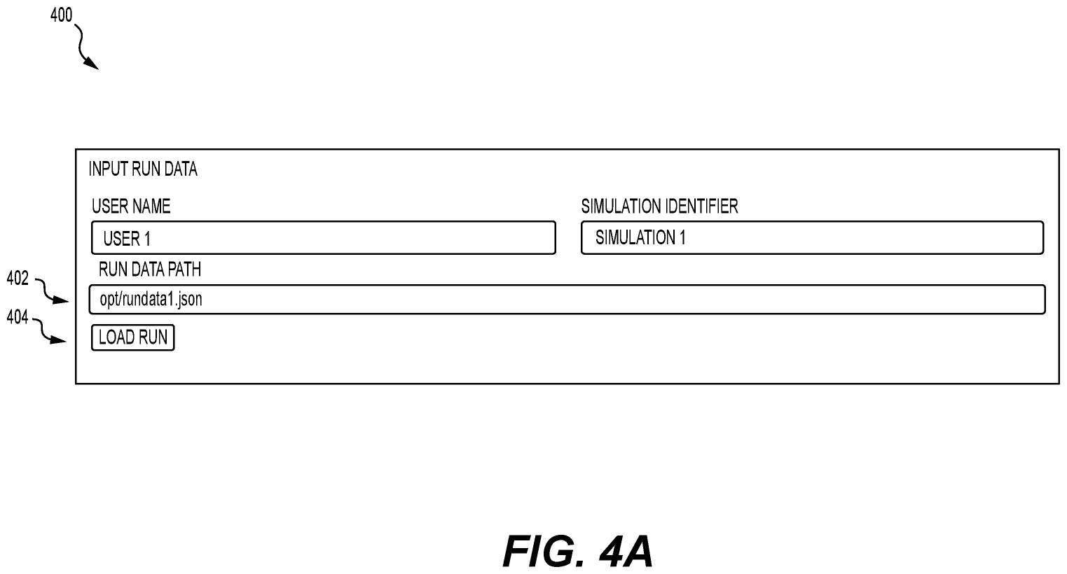

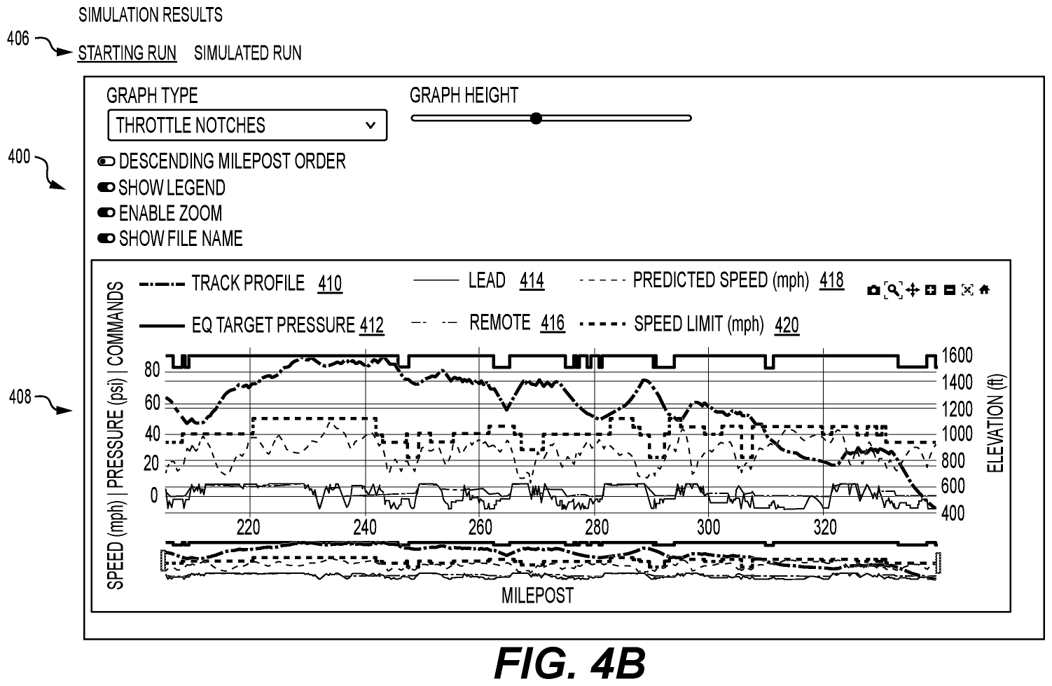

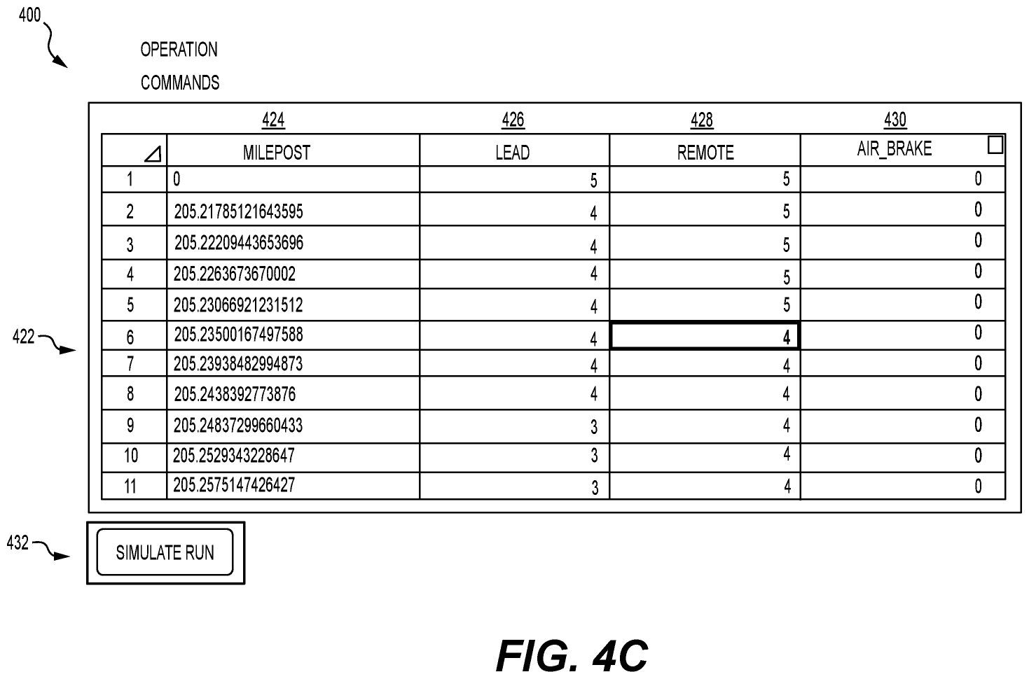

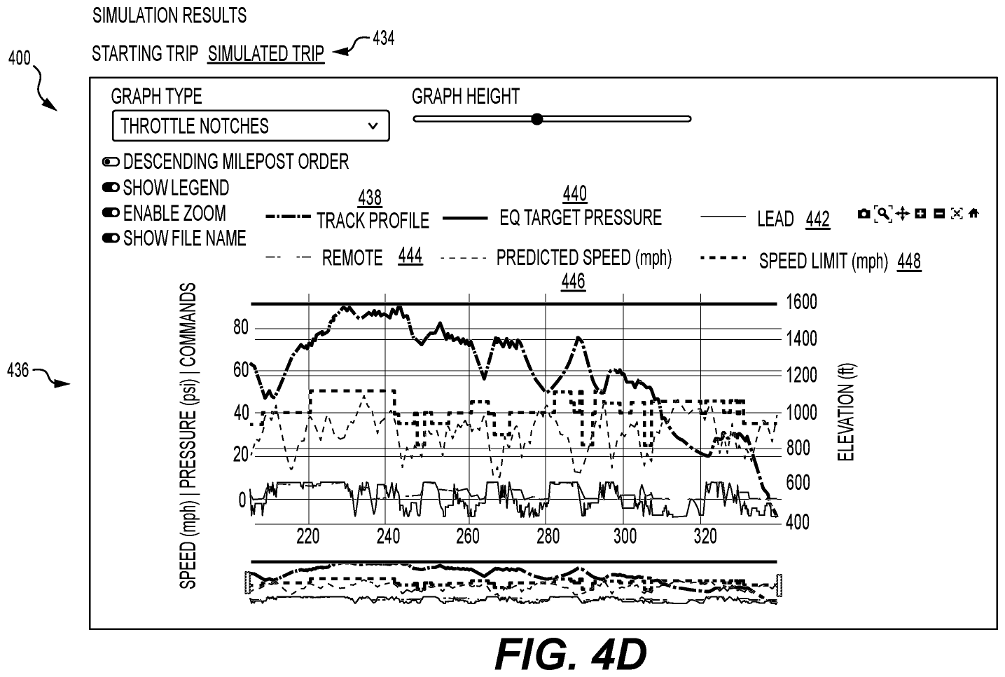

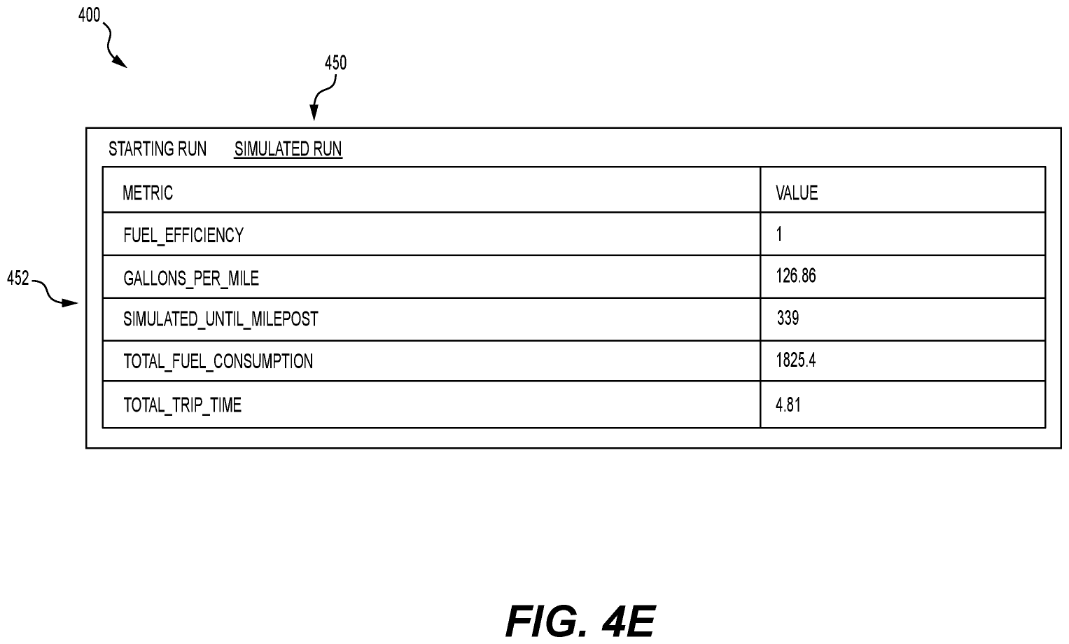

FIG. 3 is a flowchart illustrating an exemplary method 300 of generating synthetic training data for training the AI model 170 usable to operate the train 160, and FIGS. 4A-4E illustrate an exemplary user interface 400 for generating synthetic training data for training the AI model 170 usable to operate the train 160. While certain operations are described as being performed by certain devices, it should be understood that such operations may be performed by different devices and/or different combinations of devices. Further, it should be understood that one or more of the operations below may be performed concurrently and/or in an order different than the order presented below. Additionally, in various embodiments, one or more of the following operations may be omitted, and/or additional operations may be added.

At block 310, the method may include obtaining run data corresponding to a real-world run of a train 160. For example, the platform 120 may obtain run data corresponding to a real-world run of the train 160. The platform 120 may obtain the run data from the run data database 130. For example, a user may provide a user input to the user device 110 that specifies particular run data to be used to generate synthetic training data, and the platform 120 may obtain the run data based on the user input. As a particular example, and as shown by reference number 402 in FIG. 4A, the user may provide a user input that provides an identifier of the run data, and, as shown by reference number 404, may provide a user input that selects a user interface element that causes the platform 120 to obtain the run data associated with the identifier.

At block 320, the method may include generating a physics-based simulation of the real-world run of the train 160, based on the run data. For example, the platform 120 may generate a physics-based simulation of the real-world run of the train 160, based on the run data. The platform 120 may generate the physics-based simulation based on obtaining the run data from the run data database 130.

The physics-based simulation may refer to a physics-based simulation of the actual real-world run of the train 160 on the track along the route from the initial location to the destination. The platform 120 may generate the physics-based simulation based on one or more models and the run data. For example, the platform 120 may generate the physics-based simulation by implementing one or more models and by using the control parameter information, the track information, the signaling information, the train consist information, the environment information, and/or the like.

The one or more models may include a forward dynamics model. The forward dynamics model may receive control parameter information as an input, and determine a position of the train 160, a speed of the train 160, an acceleration of the train 160, internal forces of the train 160, or the like, as an output. Additionally, or alternatively, the one or more models may include an inverse dynamics model. The inverse dynamics model may receive a motion characteristic of the train 160 as an input, and determine control parameter information that produces the motion characteristic as an output. For example, the inverse dynamics model may receive a position of the train 160, a speed of the train 160, an acceleration of the train 160, or the like, as an input, and determine control parameter information that produces the position of the train 160, the speed of the train 160, the acceleration of the train 160, or the like, as an output. As another example, the inverse dynamics model may receive a speed of the train 160, a horsepower per location of the train 160, a traction effort of the train 160, a braking efficiency of the train 160, or the like, as an input, and determine control parameter information that produces the speed of the train 160, the horsepower per location of the train 160, the traction effort of the train 160, the braking efficiency of the train 160, or the like, as an output.

The platform 120 may generate the physics-based simulation by implementing the one or more models and by using the run data, and provide simulation results as an output. For example, the platform 120 may generate the physics-based simulation by implementing the one or more models and by using the control parameter information, the track information, the signaling information, the train consist information, the environment information, and/or the like, as an input, and determine a speed of the train 160, a total fuel consumption of the train 160, a total time travelled, a time to destination, a distance traveled, internal forces of the train 160, or the like, as simulation outputs.

The platform 120 may generate the physics-based simulation, determine simulation outputs, generate a user interface that displays simulation outputs, and provide the user interface to the user device 110 to permit, or cause, the user device 110 to display the user interface.

As an example, and as shown in FIG. 4B, the user device 110 may display a user interface 400 that displays simulation outputs. As shown by reference number 406, the user interface 400 may display a user interface element that indicates that the simulation corresponds to the run data of the real-world run. As shown by reference number 408, the user interface 400 may display simulation outputs. For example, as shown by reference number 410, the user interface 400 may display a track profile that identifies an elevation of the track at various locations along the route. As shown by reference number 412, the user interface 400 may display an equalizing reservoir target pressure of the train 160. As shown by reference number 414, the user interface 400 may display a speed of a lead locomotive of the train 160. As shown by reference number 416, the user interface 400 may display a speed of a remote unit of the train 160. As shown by reference number 418, the user interface 400 may display a predicted speed of the train 160. As shown by reference number 420, the user interface 400 may display a speed limit of the route.

At block 330, the method may include receiving a user input modifying at least one operation command of the train 160 in the physics-based simulation. For example, the platform 120 may receive a user input modifying at least one operation command of the train 160 in the physics-based simulation.

The platform 120 may generate a user interface that permits a user of the user device 110 to modify, in the physics-based simulation, operation commands issued to the train 160 in the physics-based simulation. Further, the platform 120 may provide the user interface to the user device 110 to permit, or cause, the user device 110 to display the user interface.

The user device 110 may receive the user interface from the platform 120, and display the user interface. A user of the user device 110 may provide various user inputs modifying the operation commands in the physics-based simulation. For example, a user may provide a user input that modifies a throttle command issued to a throttle of the train 160 in the physics-based simulation, may provide a user input that modifies a braking command issued to a dynamic brake of the train 160 in the physics-based simulation, or the like.

The user interface may include user interface elements that permit the user to modify the operation commands in the physics-based simulation. For example, the user interface may include user interface elements such as tables, charts, menus, sliders, graphs, etc., that permit the user to modify the operation commands in the physics-based simulation. The user interface may display location information to which the operation commands correspond. For example, the user interface may display a milepost to which the operation commands correspond.

The user interface may display the operation commands that may be modified by the user. For example, the user interface may display a table including the operation commands that may be modified. Alternatively, the user interface may receive a user input that searches for a particular operation command, and may display the operation command based on the user input.

The user interface may display a representation of the train 160 that permits the user to select a particular vehicle of the train consist, a particular component of the train 160, or the like. In this case, the user interface may display operation commands corresponding to the selected vehicle, the selected component, or the like.

The user interface may display a representation of the route. In this case, a user may provide a user input that selects a particular location, or section, along the route. Based on the user input, the user interface may display operation commands that correspond to the selected location, or section, along the route.

The user interface may display a representation of the train 160 travelling along the route in the physics-based simulation. For example, the user interface may display a representation of the train 160 and a representation of the track of the route.

As shown by reference number 422 in FIG. 4C, the user interface 400 may include a table that permits a user to modify operation commands issued to the train 160 in the physics-based simulation. As shown by reference number 424, the user interface 400 may include a milepost column that displays a milepost to which the respective operation commands correspond. As shown by reference number 426, the user interface 400 may include a lead locomotive throttle operation command column. As shown by reference number 428, the user interface 400 may include a remote unit throttle operation command column. As shown by reference number 430, the user interface 400 may include an air brake operation command column. The user may interact with the table to modify the operation commands. For example, the user may modify an operation command from a value of “4” to a value of “5” in association with a milepost corresponding to the sixth row of the table. As shown by reference number 432, the user may select a user interface element that causes the platform 120 to update the physics-based simulation based on modifying one or more operation commands.

At block 340, the method may include updating the physics-based simulation based on the received user input. For example, the platform 120 may update the physics-based simulation based on the received user input that modifies an operation command in the physics-based simulation.

The updated physics-based simulation may refer to an updated physics-based simulation of the actual real-world run of the train 160 on the track along the route from the initial location to the destination. The platform 120 may generate the updated physics-based simulation by implementing one or more models, and by using the run data and the modified operation commands. For example, the platform 120 may generate the updated physics-based simulation by implementing one or more models, and by using the control parameter information, the modified operation commands, the track information, the signaling information, the train consist information, the environment information, and/or the like.

The platform 120 may generate the updated physics-based simulation by implementing the one or more models, the run data, and the modified operation commands. Further, the platform 120 may provide updated simulation results as an output. For example, the platform 120 may generate the updated physics-based simulation by implementing the one or more models, and by using the control parameter information, the modified operation commands, the track information, the signaling information, the train consist information, the environment information, and/or the like, as an input, and determine a speed of the train 160, a total fuel consumption of the train 160, a total time travelled, a time to destination, a distance traveled, internal forces of the train 160, or the like, as updated simulation outputs.

The platform 120 may generate the updated physics-based simulation, determine updated simulation outputs, generate a user interface that displays the updated simulation outputs, and provide the user interface to the user device 110 to permit, or cause, the user device 110 to display the user interface.

The user interface may display an indicator identifying whether the simulation outputs are improved with respect to the initial simulation outputs of the initial physics-based simulation. For example, the user interface may display an indicator identifying that a total fuel consumption is decreased, may display an indicator identifying that a fuel efficiency is increased, may display an indicator identifying that a time to destination is decreased, or the like.

As an example, and as shown in FIG. 4D, the user device 110 may display a user interface 400 that displays updated simulation outputs. As shown by reference number 434, the user interface 400 may display a user interface element that indicates that the simulation corresponds to a run including modified operation commands. As shown by reference number 436, the user interface 400 may display updated simulation outputs. For example, as shown by reference number 438, the user interface 400 may display a track profile that identifies an elevation of the track at various locations along the route. As shown by reference number 440, the user interface 400 may display an equalizing reservoir target pressure. As shown by reference number 442, the user interface 400 may display a speed of a lead locomotive of the train 160. As shown by reference number 444, the user interface 400 may display a speed of a remote unit of the train 160. As shown by reference number 446, the user interface 400 may display a predicted speed of the train 160. As shown by reference number 448, the user interface 400 may display a speed limit of the route.

As an example, and as shown in FIG. 4E, the user interface 400 may display a user interface 400 that displays updated simulation results. As shown by reference number 450, the user interface 400 may display a user interface element that indicates that the simulation corresponds to a run including modified operation commands. As shown by reference number 452, the user interface 400 may simulation results, such as metrics including fuel efficiency, gallons per mile, a time until a particular milepost, a total fuel consumption, and a total trip time. Moreover, the user interface 400 may display values corresponding to the particular metrics.

In this way, a user may provide user inputs that modify operation commands to provide driving behavior that produces improved metrics. Moreover, the user may provide user inputs that modify operation commands to provide driving behavior that reflects particular policies of the operating entity of the train 160, that reflects institutional knowledge of best practices in certain situations, that reflects safety policies, or the like. Accordingly, in this way, the user input may account for factors that are difficult, or otherwise impossible, to model in a quantitative fashion.

At block 350, the method may include generating the synthetic training data for training an AI model 170, based on the updated physics-based simulation. For example, the platform 120 may generate the synthetic training data for training an AI model 170, based on the updated physics-based simulation.

The platform 120 may generate the synthetic training data based on the run data and the modified operation commands. For example, the platform 120 may modify the run data to reflect the modified operation commands.

The platform 120 may provide the synthetic training data to the synthetic training data database 140. The training platform 150 may obtain the synthetic training data, and train the AI model 170 using the synthetic training data and a training technique. Based on training the AI model 170, the training platform 150 may provide the AI model 170 to the train 160. The AI model 170 may be configured to operate the train 160, such as by controlling a throttle of the train 160, controlling a brake of the train 160, etc.

The platform 120 may iteratively generate synthetic training data using already-generated synthetic training data stored in the synthetic training data database 140. For example, the platform 120 may iteratively perform the operations of FIG. 3 using the synthetic training data.

The platform 120 may be used in combination with a simulation and optimization tool to generate a synthetic data training dataset when exploring new conditions or to push the system away from a local and/or a mathematical optimum. For instance, the user may modify the operation commands and/or the run data to explore different speed limit scenarios, to explore different train controls to evaluate driving strategy characteristics, to explore different speed trajectories to evaluate commands and driving strategy feasibility.

It will be apparent to those skilled in the art that various modifications and variations can be made to the disclosed method and system without departing from the scope of the disclosure. Other embodiments of the method and system will be apparent to those skilled in the art from consideration of the specification and practice of the apparatus and system disclosed herein. It is intended that the specification and examples be considered as exemplary only, with a true scope of the disclosure being indicated by the following claims and their equivalents.

What is claimed is:

1. A computer-implemented method of generating synthetic training data for training an artificial intelligence (AI) model usable to operate a train, the method comprising:
obtaining run data corresponding to a real-world run of the train, the run data including control parameter information indicative of operation commands issued to the train during the run;
generating a physics-based simulation of the real-world run of the train, based on the run data;
receiving a user input modifying at least one operation command of the train in the physics-based simulation;
updating the physics-based simulation based on the received user input; and
generating the synthetic training data for training the AI model, based on the updated physics-based simulation.

2. The computer-implemented method of claim 1, wherein the generating of the physics-based simulation includes implementing a forward dynamics model that receives the control parameter information as an input, and determines one or more of a position of the train, a speed of the train, an acceleration of the train, or internal forces of the train, or as an output.

3. The computer-implemented method of claim 1, wherein the generating of the physics-based simulation includes implementing an inverse dynamics model that receives a motion characteristic of the train as an input, and determines simulated control parameter information that produces the motion characteristic as an output.

4. The computer-implemented method of claim 1, further comprising:
determining simulation outputs, of the physics-based simulation, including one or more of a speed of the train, a total fuel consumption of the train, a total time travelled, a time to a destination, a distance traveled, or internal forces of the train.

5. The computer-implemented method of claim 1, further comprising:
causing a user device associated with a user to output a user interface, wherein the user input is received from the user via the user interface.

6. The computer-implemented method of claim 5, further comprising:
causing the user interface to display location information corresponding to the operation commands.

7. The computer-implemented method of claim 1, wherein the generating of the physics-based simulation is further based on one or more of track information, signaling information, train consist information, or environment information.

8. The computer-implemented method of claim 7, wherein the control parameter information identifies one or more of a throttle operation command issued to a throttle of the train, an air brake operation command issued to an air brake of the train, or a dynamic brake operation command issued to a dynamic brake of the train.

9. The computer-implemented method of claim 7, wherein the track information identifies one or more of an elevation of a track or a curvature of the track of the run.

10. The computer-implemented method of claim 7, wherein the signaling information identifies one or more of signals of a route of the run, speed restrictions of the route, track speeds of the route, or work zones along the route.

11. The computer-implemented method of claim 7, wherein the train consist information identifies one or more of a train identifier of the train, a model identifier of the train, a number of locomotives of the train, a number of remote units of the train, a number of cars of the train, a cargo of a train, or a weight distribution of the train.

12. A device configured to generate synthetic training data for training an artificial intelligence (AI) model usable to operate a train, the device comprising:
a memory configured to store instructions; and
a processor configured to execute the instructions to perform operations comprising:
obtaining run data corresponding to a real-world run of the train, the run data including control parameter information indicative of operation commands issued to the train during the run;
generating a physics-based simulation of the real-world run of the train, based on the run data;
receiving a user input modifying at least one operation command of the train in the physics-based simulation;
updating the physics-based simulation based on the received user input; and
generating the synthetic training data for training the AI model, based on the updated physics-based simulation.

13. The device of claim 12, wherein the generating of the physics-based simulation includes implementing a forward dynamics model that receives the control parameter information as an input, and determines one or more of a position of the train, a speed of the train, an acceleration of the train, or internal forces of the train, or as an output.

14. The device of claim 12, wherein the generating of the physics-based simulation includes implementing an inverse dynamics model that receives a motion characteristic of the train as an input, and determines simulated control parameter information that produces the motion characteristic as an output.

15. The device of claim 12, wherein the operations further comprise:
determining simulation outputs, of the physics-based simulation, including one or more of a speed of the train, a total fuel consumption of the train, a total time travelled, a time to a destination, a distance traveled, or internal forces of the train.

16. The device of claim 12, wherein the operations further comprise:
causing a user device associated with a user to output a user interface, wherein the user input is received from the user via the user interface.

17. The device of claim 16, wherein the operations further comprise:
causing the user interface to display location information corresponding to the operation commands.

18. The device of claim 12, wherein the generating of the physics-based simulation is further based on one or more of track information, signaling information, train consist information, or environment information.

19. The device of claim 18, wherein the control parameter information identifies one or more of a throttle operation command issued to a throttle of the train, an air brake operation command issued to an air brake of the train, or a dynamic brake operation command issued to a dynamic brake of the train.

20. A non-transitory computer-readable medium configured to store instructions that, when executed by a processor configured to generate synthetic training data for training an artificial intelligence (AI) model usable to operate a train, cause the processor to perform operations comprising:
obtaining run data corresponding to a real-world run of the train, the run data including control parameter information indicative of operation commands issued to the train during the run;
generating a physics-based simulation of the real-world run of the train, based on the run data;
receiving a user input modifying at least one operation command of the train in the physics-based simulation;
updating the physics-based simulation based on the received user input; and
generating the synthetic training data for training the AI model, based on the updated physics-based simulation.
